(19) United States
(12) Patent Application Publication
(10) Pub. No.: US 2024/0070537 A1
(43) Pub. Date: Feb. 29, 2024

(54) Microscopy System and Method for Generating a Machine-Learned Model for Processing Microscope Data

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 18/235,548

(22) Filed: Aug. 18, 2023

(30) Foreign Application Priority Data
Aug. 25, 2022 (DE) 10 2022 121 545.8

(51) Int. Cl. G06N 20/00

(52) U.S. Cl. CPC G06N 20/00

(57) ABSTRACT

A machine-learned model for processing microscope data is trained using a dataset containing microscope data. An embedding of the dataset in a feature space is calculated. The embedding is analyzed in order to determine training design specifications for a training of the model. The training is defined as a function of the training design specifications and subsequently implemented, whereby the model is configured to calculate a processing result from microscope data to be processed.

### REFERENCE TO RELATED APPLICATIONS

The current application claims the benefit of German Patent Application No. 10 2022 121 545.8, filed on 25 Aug. 2022, which is hereby incorporated by reference.

### FIELD OF THE DISCLOSURE

The present disclosure relates to a microscopy system and to a computer-implemented method for generating a machine-learned model for processing microscope data.

### BACKGROUND OF THE DISCLOSURE

The importance of the role of machine-learned models is continuously increasing in modern microscopy systems, in particular in the areas of image processing and data evaluation. Machine-learned models are used, for example, to automatically localize a sample or for an automated sample analysis, for example in order to measure an area covered by biological cells by segmentation or to automatically count a number of cells. Learned models are also employed to virtually stain sample structures or for image enhancement, e.g. for noise reduction, resolution enhancement or artefact removal.

In many cases microscope users train such models themselves with their own data. Microscopy software developed by the Applicant allows users to carry out training processes using their own data without expertise in the area of machine learning. This is important as it helps to ensure that the model is suitable for the type of images handled by the user. There are also efforts to automate to the greatest possible extent training processes that incorporate new microscope data.

The implementation of the training of a model has a decisive effect on the resulting quality of the model. Quality is notably influenced by, for example, the chosen model architecture or complexity, hyperparameters of the training, a preparation of the dataset for the training, and a division of the dataset into training and validation data. If the training is to performed in a largely automated manner, it is necessary for these factors to be aptly defined to the greatest possible extent automatically. To date, however, it has been necessary for experienced experts to carry out extensive activities in order to obtain a high model quality.

For example, the manual division of a dataset into training and validation data requires considerable experience yet enables higher-quality results compared to automated divisions defined based on simple criteria, e.g. the use of every tenth image of the dataset as a validation image. The use of such simple divisions can easily lead to a bias and an overfitting in the model that are not necessarily identified when the model is tested using the validation data. For instance, a machine-learned model is intended to discriminate different types of bacteria. Microscope images relating to one of these types of bacteria are respectively captured on different measurement days. However, noise characteristics of captured microscope images differ as a function of the measurement day. It can thus occur that the model learns to discriminate types of bacteria based on the noise characteristics of the images (and not based on the appearance of the bacteria) because it is possible to discriminate the measurement days and thus the types of bacteria perfectly by means of the noise characteristics. If the validation data have been drawn randomly from the overall dataset, the validation will yield a very good result although the model has learned an incorrect interpretation of the data and it is unlikely that the model will be able to correctly identify types of bacteria in other microscope images (with different noise characteristics).

A model complexity is usually defined manually by experts. Although automatic methods for defining the complexity and other training parameters are known, e.g. AutoML, these methods require cost-intensive and lengthy test training runs in order to be able to compare differently trained model variants with one another and so define training parameters. More information on AutoML methods can be found in: Xin He et al., arXiv:1908.00709v6 [cs.LG] 16 Apr. 2021, “AutoML: A Survey of the State-of-the-Art”.

A model quality can also be compromised by outliers in the training data. In a classification task, for example, an outlier can be a microscope image with an incorrect class designation. Outliers in the training data are often not identified at all. In principle, outliers can be identified after the training by comparing a prediction with a ground truth annotation. In order for outliers to be identifiable via this comparison, however, it is imperative that the model has not already memorized the incorrectly annotated data so as to make predictions based on this data. The identification of outliers is thus often only possible with considerable effort and limited reliability.

Reference is made to X. Glorot et al. (2010): “Understanding the difficulty of training deep feedforward neural networks” as background information. This article describes typical steps in the training and validation of a neural network. It also explains how suitable values for, e.g., the learning rate as well as designs and parameters of the activation functions of a model can be determined.

Significant improvements in terms of a reduction of the number of model parameters to be learned and in terms of an independence of the model parameters from one another are described in: HAASE, Daniel; AMTHOR, Manuel: “Rethinking depthwise separable convolutions: How intra-kernel correlations lead to improved MobileNets”, arXiv:2003.13549v3 [cs.CV] 13 Jul. 2020.

As further background, reference is also made to Laurens van der Maaten, Geoffrey Hinton, “Visualizing Data using t-SNE” in Journal of Machine Learning Research 9 (2008) 2579-2605, and to Laurens van der Maaten, “Accelerating t-SNE using Tree-Based Algorithms” in Journal of Machine Learning Research 15 (2014) 1-21, and to Jörn Lötsch et al., “Current Projection Methods-Induced Biases at Subgroup Detection for Machine-Learning Based Data-Analysis of Biomedical Data”, in Int. J. Mol. Sci. 2020, 21, 79; doi:10.3390/ijms21010079. These articles describe how a dataset can be represented in a more readily interpretable manner. To this end, a t-distributed stochastic neighbor embedding is employed.

A method for an automatic data augmentation is described in Ekin D. Cubuk et al., “AutoAugment: Learning Augmentation Strategies from Data”, arXiv:1805.09501v3 [cs.CV] 11 Apr. 2019. By means of an augmentation, images or other data of a training dataset are slightly modified in order to generate further training data from the same. In AutoAugment an augmentation strategy is derived using the available data. A known model is trained with the available data in order to learn an optimal policy with a reinforcement learning approach based on a random validation sample. The same drawback is thus encountered as in the division of the dataset into training and validation data, since the validation data can potentially be subject to a bias here. It is also not possible to derive the strategy directly from the data, so that the effort involved in a data augmentation is potentially high.

### SUMMARY OF THE DISCLOSURE

It can be considered an object of the invention to provide a microscopy system and a method which determine a suitable training for a model based on a given dataset so that a processing of captured microscope data is carried out with a quality that is as high as possible and an error rate that is as low as possible.

This object is achieved by the microscopy system and the method with the features of the independent claims.

In a computer-implemented method according to the invention for generating a machine-learned model for processing microscope data, a dataset containing microscope data is obtained for training the model. An embedding of the dataset in a feature space is calculated, i.e. an embedding of the microscope data or data derived from the same in a low-dimensional feature space. The embedding is analyzed in order to determine training design specifications for a training of the model. The training of the model is subsequently defined as a function of the training design specifications. The training is then implemented, whereby the model is configured to be able to calculate a processing result from microscope data to be processed.

A microscopy system according to the invention comprises a microscope for image capture and a computing device that is configured to carry out the computer-implemented method according to the invention. The microscope can in particular be configured to capture the microscope data or raw data from which the microscope data is obtained.

The computer program according to the invention comprises commands that, when the program is executed by a computer, cause the execution of the method according to the invention.

The invention makes it possible to identify factors that are relevant for the training already before the training, in particular automatically, based on an embedding of training data in a low-dimensional feature space.

This stands in contrast to the AutoML methods mentioned in the introduction in which a plurality of differently trained variants of a model are compared with one another, which requires to run the time-consuming and computationally laborious training several times. For example, the invention allows recommendations for hyperparameters based on the dataset, whereas AutoML determines recommendations for hyperparameters only based on trained models. Hyperparameter optimization with AutoML can thus suffer from a bias in the validation, in particular when a performed division of the dataset into training and validation data was not ideal. The invention also allows recommendations to be made for the preparation of the training data, in particular for a division into training and validation data, which is not possible with AutoML. In contrast to the present invention, it is also not possible to find outliers in the dataset with AutoML.

### Optional Features

Variants of the microscopy system according to the invention and of the method according to the invention are the object of the dependent claims and are explained in the following description.

### Dataset

The dataset comprises microscope data of which at least a part is intended to be used as training and validation data for the model.

Microscope data denotes measurement data of a microscope or data calculated therefrom. For example, microscope data can be microscope images, which can be understood in general as image data, in particular as image stacks or volumetric data.

Microscope images or in general data of the dataset are used as input data for the model to be trained. In the case of a supervised training, the dataset also comprises annotations—e.g. a target image, one or more class labels or a segmentation mask—for each microscope image. The annotations are used as a calculation target or ground truth in the training. It is also possible to use microscope data that is only partially annotated for a partially supervised training. Optionally, the dataset can also comprise contextual information, which will be explained in greater detail later on. In the case of an unsupervised training, the dataset does not need to comprise annotations.

### Embedding of the Dataset

Microscope data of the dataset can be represented in the embedding as, e.g., a point cloud in a feature space. A point in the feature space is called an embedded data point in the following and represents a microscope image of the dataset (or more generally a data object of the dataset). Optionally, an annotation and/or contextual information can be provided for microscope data, e.g. for a microscope image, of the dataset (and thus for an embedded data point). The annotations and optionally the contextual information need not be taken into account in the calculation of the embedding, whereby they have no direct effect on a position of an embedded data point in the feature space.

Optionally, the embedding can be visualized in order to facilitate a semi-automatic data analysis. In this case, the embedding is displayed on a screen and a user is provided with input options for selecting data points. If the user selects a data point, the associated microscope data is displayed. An embedded data point does not necessarily have to be represented as a point in the visualization; it is rather also possible for, e.g., a thumbnail view of an associated microscope image to be displayed instead. An embedded data point is thus characterized by its coordinates in the feature space relative to the other embedded data points, while an optional display can take different forms.

### Calculating at Least One Embedding of the Dataset

The embedding of the dataset in the feature space can be calculated in an essentially known manner. By means of a dimensionality reduction method, the high-dimensional dataset is converted into, e.g., a two- or three-dimensional dataset (embedding). The dimensionality reduction is intended to preserve the significant content of the high-dimensional data as much as possible.

Calculating the embedding can optionally occur in multiple steps, wherein a feature vector is first extracted from a microscope image or generally speaking from a data object of the dataset. The feature vectors are then embedded in a (dimensionally reduced) feature space.

For example, microscope images/data objects of the dataset can first be input into a machine-learned feature extractor. In general, a feature extractor maps an input to a dimensionally reduced output and then calculates a feature vector from each microscope image. The feature vectors can be represented or embedded in the feature space. The feature space thus does not have to be spannable by the feature vectors, but can have a lower dimension than the feature vectors, which an embedding brings about. Feature extractors implemented by means of deep neural networks have been sufficiently described in the relevant literature. The feature extractor (an extraction model) can be trained with the dataset and/or with other data and is run for each data object in the dataset in order to calculate an associated feature vector. In order to accelerate the feature extraction, separated convolution kernels can be used like the Blueprint Separable Convolutions described in the article by HAASE, Daniel; AMTHOR, Manuel cited above: “Rethinking depthwise separable convolutions: How intra-kernel correlations lead to improved MobileNets”, arXiv:2003.13549v3 [cs.CV] 13 Jul. 2020.

The embedding can be calculated, for example, by means of a stochastic neighbor embedding (SNE), in particular by means of a t-distributed stochastic neighbor embedding (t-SNE). Input data of the SNE can be the microscope data of the dataset, e.g. microscope images, or feature vectors derived therefrom. In an SNE, distances (e.g. high-dimensional Euclidean distances) between pairs of microscope images or between the feature vectors are first converted into conditional probabilities, which represent similarities between the pair of microscope images or between the pair of feature vectors. A probability distribution is used here, which in the case of a standard SNE has the form of a Gaussian distribution and in the case of a t-SNE has the form of a Student's t-distribution. The similarity between a first and a second microscope image or feature vector is indicated as a conditional probability that the first microscope image/feature vector would draw the second microscope image/feature vector as its neighbor from a probability distribution. The probability distribution is centered around the first microscope image/feature vector and becomes smaller as a distance of a microscope image/feature vector from the first microscope image/feature vector increases. The conditional probability is thus smaller, the more dissimilar the two microscope images/feature vectors are to each other. If another pair is considered, a probability distribution centered around a microscope image/feature vector of this pair is used. A corresponding conditional probability is defined for the associated embedded data points in the dimension-reduced feature space, wherein the probability distribution indicates a distance in the dimension-reduced feature space. For a data pair, the value of this conditional probability should be equal to the value of the aforementioned conditional probability of a proximity of two microscope images/feature vectors. In SNE methods, an error between these two conditional probabilities is minimized, e.g. by minimizing the sum of the Kullback-Leibler divergence, so as to calculate the embedding.

Example implementations of a t-SNE and more general SNE methods are described in the articles cited in the introduction, i.e. in Laurens van der Maaten, Geoffrey Hinton, “Visualizing Data using t-SNE” in Journal of Machine Learning Research 9 (2008) 2579-2605; as well as in Laurens van der Maaten, “Accelerating t-SNE using Tree-Based Algorithms” in Journal of Machine Learning Research 15 (2014) 1-21. The contents of these articles are hereby incorporated in their entirety herein by reference. The dataset used in the present disclosure corresponds to the dataset X={x₁, x₂, . . . , xₙ} in the articles, so that the microscope data of the dataset corresponds to the entries x₁, x₂, . . . , xₙ. The calculated embedding is referred to in the articles as Y={y₁, y₂, . . . , yₙ}. An embedded data point thus corresponds to one of the values y₁, y₂, . . . , yₙ. The distance norm used in these publications, in particular the Euclidean distance, is to be understood as an example, i.e. other distance norms can be used instead.

The embedding method thus yields the feature space, which can in principle have any dimension that is smaller than a dimension of the original data of the dataset. The feature space can be chosen to be two- or three-dimensional to facilitate representability.

The embedding can relate to the entire dataset or, in particular with large datasets, to only a part of the dataset.

A t-SNE is conventionally only utilized for the purposes of visualization, after which a manual interpretation is necessary. By contrast, by means of the analysis processes described in greater detail later on, the invention is able to draw inferences for the training of the model, in particular inferences regarding an optimal complexity of the model to be implemented, a data division and an augmentation. It is also possible for outliers to be identified from a t-SNE embedding in an automated manner.

Input data for a t-SNE or other embedding method can be the microscope data of the dataset, in particular pixel values of microscope images. Alternatively, features extracted from the microscope data can form the input data. An extraction can occur, e.g., by means of a pre-trained CNN and/or a Fisher vector encoding. It is also possible for other features such as segmentation masks to be extracted and analyzed.

It is also possible to employ other methods instead of an SNE or t-SNE to transform or project the input data into an embedding. It is possible to use, for example, an autoencoder or some other machine-learned model with a bottleneck structure. These models can have been learned using a generic dataset, using data resembling an area of application of the dataset in question, or in principle using the dataset itself. A bottleneck layer creates a compressed, low-dimensional representation of the input data. The data output by the bottleneck layer can thus be used as an embedding. Alternatively, a principal component analysis (PCA) or an independent component analysis (ICA) can be employed. Also possible is a non-negative matrix factorization (NMS), in which a matrix is approximated by a product of matrices with fewer parameters in total, which likewise brings about a dimension reduction. General lossless or lossy compression methods are also possible because the data volume of the dataset is thereby rendered approximate to the actual Shannon entropy. Lossy compression can also filter out a noise that is generally not intended to contribute to the prediction of the machine-learned model. An output of the aforementioned methods can be an embedding; alternatively, it is also possible for the aforementioned methods to be utilized as a feature extractor prior to an SNE or t-SNE. In the latter case, input data for one of said methods, e.g. a compression method, is constituted by the microscope data, and the output data calculated therefrom is input into the SNE/t-SNE, which calculates the embedding.

### Definition of Training Design Specifications Through an Analysis of the Embedding

Training design specifications are identified based on the at least one embedding of the dataset, wherein the training design specifications relate to a design of the training of the model, in particular an architecture or complexity of the model, a preparation of the training data, a division of the dataset into training and validation data or a definition of hyperparameters of the training. The singular and plural forms of the term “training design specifications” can be understood in the present disclosure as synonymous.

The training design specifications are defined via an analysis of the embedding. In particular clusters of embedded data points can be identified in the analysis. An evaluation of a homogeneity of a cluster can also occur. The homogeneity evaluation can relate to a class label of the data points of a cluster. Alternatively or additionally, the homogeneity evaluation can also relate to a spatially homogeneous distribution of a data point cloud of embedded data points in the feature space.

Different training design specifications are explained in the following along with associated analysis processes for determining these training design specifications from an embedding.

Division of a Dataset into Training and Validation Data Based on the Embedding

A provided dataset must be divided into training and validation data, which is understood in the sense that a part of the microscope data (e.g. microscope images) of the dataset is used as training data for the model and another part of the microscope data is used as validation data. Training data is used to iteratively adjust parameter values of the model, e.g. by optimizing an objective function, wherein a parameter modification is calculated via gradient descent. Validation data, on the other hand, is used solely to evaluate a quality of the model and is not used to calculate a parameter modification by, e.g., gradient descent methods.

In conventional processes, a dataset is divided into training and validation data randomly or according to a simple rule that does not take into account the data content, for example a rule stipulating that, e.g., every tenth microscope image of a dataset is to be allocated as a validation image.

With the invention, on the other hand, it is possible to recommend a division of the dataset into training and validation data as a training design specification, wherein the division is determined based on an arrangement of data points embedded in the feature space. The embedded data points optionally comprise annotations or class labels. Taking into account an arrangement of the embedded data points allows a meaningful and reliable validation.

In order to determine the division, the analysis of the embedding can comprise an identification of clusters of embedded data points. A cluster can be understood as a group or collection of a plurality of data points whose distance from one another is smaller than a distance of these same data points from other data points that do not belong to the cluster.

It is possible to ascertain whether the clusters are formed homogeneously of data points with corresponding class labels. Homogeneous can be understood to mean that at least 95% or at least 98% of all data points in this cluster have the same class label. There can be, e.g., one or more homogeneous clusters per class. In the case of homogeneous clusters, data points for the validation data are selected, e.g. randomly drawn, from a plurality of clusters or from each cluster. Remaining data points are selected for the training data so that data points for the training data are selected from each of the clusters. This can in particular prevent the selection of all data points of a cluster as validation data, whereby an entire cluster (whose data differs structurally from the data of other clusters) would not be available for the adjustment of the model parameter values. If data points for the validation data are selected from each cluster (or from, e.g., at least 80% of all clusters), this is likely to enable a particularly informative validation since the validation covers a large part of the structurally different datasets.

A selection of a “data point” for the training or validation data or an allocation of a data point as training or validation data is intended to be understood in the sense that the microscope data that belongs to this data point is selected as training or validation data. It is thus not the embedded data points that are input into the model, but the associated microscope data.

In other words, in the case of homogeneous clusters, microscope data whose associated embedded data points cover different clusters or all clusters are selected as validation data. Microscope data whose associated embedded data points cover all clusters are selected as training data in this case.

In contrast, a different division into training and validation data can be recommended when non-homogeneous (inhomogeneous) clusters are established, i.e. when the data points of a cluster have different class labels. This can occur, e.g., when microscope data were captured with different microscopes and the microscope data of different microscopes differ in a structural manner, e.g. due to a different noise behavior, different illumination characteristics or due to components such as sample carriers or sample carrier holders that are visible in captured images. As a result of this kind of bias, the microscope data of different microscopes form different clusters. The dataset can potentially still be suitable for a training of the model if the data points are separated within a cluster according to their class label. Different cases in which inhomogeneous clusters are either suitable or not suitable for a training are described later on. This depends on the type and effect of a bias, which in some cases renders a class detection by the model difficult or even impossible. In the case of non-homogeneous clusters, a division of the dataset into training and validation data can occur so that the data points of one of the clusters (in particular all data points of this cluster) are selected as validation data, while no data points of this cluster are selected as training data. Conversely, data points from a plurality of other clusters are only used for training data but not for validation data. Based on this division of the data, the validation data allows a meaningful statement with regard to the generalizability of the model. If the model trained without the data of a particular cluster can correctly predict class labels for that cluster in the validation, a good generalizability can be assumed while an influence of the bias (which can be unknown for microscope data to be analyzed in the inference phase) does not seem to unduly compromise the class detection. If, on the other hand, the bias strongly compromises the class detection, a correspondingly poorer model quality can be established with the validation data. This validation statement would not be reliably possible with a different division into training and validation data: for example, if the training data were to comprise data points from each cluster, the bias of the training data would end up being memorized by the model if the training were to go on long enough. The validation data would thus always suggest a high model quality. That the bias actually had a strong effect on a classification result of the model would remain undetected. An analysis of microscope data with a different bias in the inference phase would thus lead to erroneous results in spite of the high model quality determined based on the validation data.

The determination of a suitable division of the dataset into training and validation data can be combined with the determination of an aptness of the dataset described in the following.

### Determining an Aptness of the Dataset Through an Analysis of the Embedding

There can occur an estimation based on the embedding of the dataset whether the dataset is suitable for a training of the model. A determined indication of aptness can be output as a training design specification.

First, clusters of embedded data points with annotations/class labels are identified in the analysis of the embedding. An analysis is then carried out to ascertain whether the clusters are formed homogeneously from data points with corresponding class labels. If this is the case, an aptness of the dataset for a training of the model is affirmed.

For inhomogeneous clusters, an aptness of the dataset can be negated if data points are not separable according to their class label within a cluster, i.e. if data points with a corresponding class label are not separable within a cluster from data points with a different class label. With reference to the data points within a cluster, “separable” can be understood to mean that, for each class label, a contiguous area in the feature space respectively includes all data points of the class label. This is not the case, for example, when data points of different annotations are intermixed haphazardly within a cluster.

Alternatively or additionally, in cases where data points within clusters are separable according to their class label, an aptness can be affirmed or negated as a function of a generalizability of a class separation rule. An aptness is provided if a generalizability of a class separation rule is affirmed. For example, a class separation rule to separate data points according to their class label can be derived from the data points of a plurality of (but not all) clusters. The class separation rule thus defines different regions in the feature space by which data points with a corresponding class label are separated from data points with a different class label. A generalizability is affirmed when the class separation rule also holds true for data points of another cluster that was not used to determine the class separation rule.

It is possible based on the generalizability to discriminate whether there is a bias that still allows a separation of classes or whether there is a dominant bias that renders a separation of the data points according to their class impossible.

Evaluation of a Provided Division of the Dataset into Training and Validation Data Based on the Embedding

It can occur that a division of the dataset into training and validation data has already been provided. A division of the dataset can have been determined manually by a user or by an automated process. An aptness of the already provided division of the dataset can be tested or evaluated using the embedding.

The analysis of the embedding can occur as described in the foregoing with reference to the determination of a division of the dataset based on the embedding.

It can in particular first be determined whether homogeneous clusters are present. In cases of homogeneous clusters of data points with corresponding class labels, an aptness of the provided division is affirmed if the validation data includes data points from at least a plurality of clusters, in particular from all clusters, and if the training data includes data points from all clusters.

Additionally or alternatively, in cases of inhomogeneous clusters, it can be stipulated that a provided division is categorized as suitable depending on of whether an inhomogeneous cluster is present whose data points have been selected solely for validation data and not for training data. It can be stipulated that an aptness is affirmed in the affirmative case. More detailed explanations regarding an aptness are given above with reference to the division of a dataset based on the embedding.

### Determination of Outliers of the Dataset Based on the Embedding

Outliers are understood in the present disclosure as incorrect data that differ significantly from correct, expected data. An outlier can be caused by an error in measurement, for example when a blank image is captured without an actual measurement object. An outlier can also be caused by an inaccurate data annotation, for example when a user assigns an incorrect class label to a microscope image.

One or more outliers of the dataset can be identified and indicated as a training design specification. For example, in a visualization of the embedding, the embedded data points that have been identified as outliers can be marked and optionally listed.

Outliers can be identified by analyzing the embedding, wherein a data point is identified as an outlier as a function of its position in the embedding. Identification as an outlier can also occur as a function of an optional annotation. A data point can in particular be identified as an outlier if the data point is further away from directly adjacent data points than a given threshold value. The threshold value can be chosen as a function of distances between other data points. For example, an average distance between directly adjacent data points in the embedding can be ascertained and the threshold can be set as a predefined multiple of the average distance. If class labels are provided, a data point with a certain class label can then be identified as an outlier if the data point is further away from directly adjacent data points with the same class label than a given threshold value.

Alternatively or additionally, a data point with a given class label can be identified as an outlier if it is located within a (homogeneous) cluster of data points with a different class label. A cluster can be categorized as homogeneous when, e.g., at least 95% or 98% of all data points in the cluster have a corresponding annotation. Data points with a different annotation can be categorized as outliers within such a homogeneous cluster.

An identified outlier can be automatically removed from the dataset or excluded from training or validation data. Alternatively, an identified outlier can be displayed to a user in order to check, for example, a manually assigned annotation. A recommendation for a modified annotation is optionally generated automatically, wherein the annotation of adjacent data points is proposed as the modified annotation. Such a recommendation makes particular sense when, due to a mistaken manual annotation, a data point lies within an otherwise homogeneous cluster.

### Defining Training Hyperparameters Based on the Embedding

It is also possible to define hyperparameters as training design specifications via an analysis of the at least one embedding.

A hyperparameter or training hyperparameter is understood to be a parameter that relates to a training process or to a model structure. Unlike model weights, a hyperparameter is not used in the processing of input data. With conventional methods for defining hyperparameters as known in, e.g., AutoML methods, it is necessary to conduct a plurality of computationally intensive and time-consuming test training runs. By comparison, defining hyperparameters based on the embedding saves time.

Training hyperparameters can be, e.g.: a learning rate (i.e. a parameter that defines to what extent values of model weights are modified in a gradient descent method), a number of training steps up until the termination of the training or a decay behavior of weights (weight decay). In the case of a weight decay, one or more hyperparameters describe to what extent learned values of model weights are respectively reduced in amount (i.e., their absolute values are reduced) during the training, e.g. after a given number of training steps. This is intended to prevent an overfitting to the training data.

A schedule of training hyperparameters or change of values of hyperparameters can also form the training design specifications. For example, a schedule consists of a plurality of learning rates used sequentially in the course of the training, for example after a given number of training steps or as a function of a training or validation loss.

Different approaches for defining hyperparameters are discussed in the following.

### Hyperparameters: Number of Training Steps

A number of training steps up until a termination of the training can be defined as a training hyperparameter. To this end, a complexity and/or homogeneity of the embedded data points in the feature space is ascertained. The higher the complexity found—or, conversely, the lower the homogeneity—the higher the chosen number of training steps is.

A relatively long training is likely to be necessary, e.g., if clusters of different classes lie very close to one another, if a separation of the clusters has a strongly non-linear form, if the embedding as a whole is formed in a complex manner by many dispersed clusters, and/or if clusters have a complex form.

### Defining a Model Complexity or Model Architecture Based on the Embedding

A model architecture and/or model complexity of the model to be trained can also be recommended as a training design specification. The model can comprise a feature extractor into which microscope data are input and at least one subsequent model part into which an output of the feature extractor is entered.

To determine a suitable model complexity, feature extractors of different complexities can be used. It is also possible to use multiple feature extractors with different architectures to determine a suitable model architecture. A set of feature vectors is respectively calculated from the microscope data of the dataset with each feature extractor. The feature extractors of different complexities can be machine-learned networks that differ, e.g., in a number of (convolutional) layers or generally in a number of model parameters to be learned. The networks known as ResNet-10, ResNet-34 and ResNet-50, which differ in the number of their layers, are one example.

Next, an embedding is respectively calculated from each set of feature vectors, i.e. one embedding per feature extractor.

The embeddings are compared with one another in order to select one of the feature extractors based on a separation of embedded data points of different classes and based on a clustering of embedded data points. A feature extractor is ideally selected that enables an adequate class separation but is not unnecessarily complex.

The feature extractor is most likely not complex enough if clusters of different classes overlap, if clusters have diffuse, spatially fuzzy boundaries and/or if clusters are scattered. Many particularly compact clusters with no overlap can indicate an overfitting and thus too much complexity in the feature extractor. An appropriate model complexity is provided when the data points of the same class respectively form a few compact clusters that do not overlap with clusters of other classes.

The selected feature extractor is recommended for use as part of the model. The recommendation can be adopted automatically or, for example, following approval by a user.

In a variant of the described embodiment, a single feature extractor is first used and the associated embedding is evaluated to ascertain whether the feature extractor used is too complex, insufficiently complex or suitable in terms of its complexity. This evaluation can occur based on the clusters and based on a class separation as described in the foregoing. If the evaluation indicates an insufficient complexity, a more complex feature extractor is used next, and vice versa. This procedure is repeated until a feature extractor with a suitable complexity is found.

Data Selection: Balancing Data from Different Clusters

A balance of different types of data is important in training data in order to enable a robust training. In the event of an imbalance, for example when data with a certain class label is underrepresented, this class may not be learned as well by the model or may even be ignored.

In order to create a balance, certain microscope data can be removed from the dataset or not selected for the training and validation data. A balance is checked using the embedding: different clusters of embedded data points should be about the same size, wherein size is understood as a number of data points per cluster.

In the event of different numbers of data points per cluster, a selection of data points for the training data occurs so that numbers of selected data points per cluster approximate one another. “Approximate one another” is intended to be understood in the sense that the cluster sizes differ less than the original cluster sizes given by all data points of the embedding. The size approximation can in particular occur so that the clusters differ in the number of their data points by at most 10% or 20%. A selection can also be made for the validation data by means of which the number of data points used per cluster varies by at most 10% or 20% between the clusters.

The balancing can also occur as a function of the number of clusters per class. The number of data points per class should be the same, e.g. within a precision of +1-20%. If the data points of a first class form more clusters than the data points of a second class, then the clusters of the first class should contain fewer data points than the clusters of the second class.

In variants of the described embodiments, a balancing is achieved by defining different probabilities or frequencies with which the microscope data are used in the training rather than via a specific selection of data points for the training data. Instead of reducing the number of data points of a cluster, these data points can be assigned a smaller probability or frequency with which the associated microscope data is used in the training.

### Recommending Enlarging the Dataset Based on the Embedding

Based on a distribution of data points in the embedding, it can be recommended to add new microscope data with certain characteristics to the dataset, in particular to incorporate new microscope data with these characteristics. The characteristics can in particular relate to capture parameters such as an illumination or detection setting, or to a contrast type, sample type or sample preparation type.

Enlarging the dataset can be recommended when a number of data points in a cluster is smaller than a given minimum value. In this case, microscope data of this cluster is underrepresented and it can be recommended to incorporate new microscope images corresponding in their class and optional meta-information to those of the data points of the cluster that is too small.

Additionally or alternatively, an expansion/enlargement of the dataset can be recommended if it is ascertained that data points of a class with the same class label form a plurality of clusters that are spaced apart from one another and it is possible to correlate the clusters with contextual information that is known not to cause a separation of clusters. In this case, it can be recommended to provide further microscope data of this class with a different value for the contextual information. The aforementioned correlation is to be understood in the sense that different clusters occur as a function of a difference in the contextual information. Such a separation should not occur, e.g., when the contextual information specifies a microscope user who captured the microscope data or a measurement day on which the microscope data was captured, provided that all other contextual information, such as, e.g., sample type and contrast method, is identical.

A distance between clusters can also be taken into account for the recommendation of an expansion of the dataset. For example, in cases of different measurement devices of a same or similar type, the associated data points should either form a common cluster or at the very least adjacent or close clusters. It can thus be recommended in the event of a large distance between clusters to add microscope data from further measurement devices.

Additionally or alternatively, an expansion can be recommended when a border region between clusters of different classes is categorized as diffuse or fuzzy. These clusters may be respectively homogeneous, but an adequate separation of classes is not possible within the border region. In this case, it can be recommended to provide more microscope data similar to that of the border region. If certain contextual information is characteristic of the data points of the border region, it is recommended to add microscope data with this contextual information.

An expansion of the dataset can also be recommended when a cluster is extremely compact, i.e. a measurement of the cluster in the feature space is smaller than a predefined minimum value or smaller than a predefined ratio to an average size of other clusters.

Classes or data points of classes that are not adequately separable in the embedding can be identified and optionally displayed to a user. To this end, a distribution of data points in the embedding can be used to ascertain whether a cluster of data points of one class overlaps with a cluster of data points of another class. In this case, there occurs an output of associated data points or classes together with a warning that an adequate separability is not satisfied.

### Recommendation for a Data Augmentation Based on the Embedding

A distribution of data points in the embedding can be utilized to recommend or evaluate an augmentation. An augmentation denotes calculation processes by means of which new microscope data are generated from microscope data of the dataset. An augmentation recommendation can relate to certain data points and/or a strength of the augmentation. In an augmentation, one or more mathematical operations are carried out with a definable strength, for example affine transformations such as image rotation, image distortion or scaling.

If clusters are too compact and isolated in the embedding, an augmentation of the microscope data of that cluster can be recommended in order to increase a data variance and make an overfitting less likely.

It is also possible to first carry out an augmentation in a known manner in order to subsequently calculate an embedding that also comprises the additional microscope data generated by augmentation. This embedding is analyzed according to the aforementioned criteria in order to make a statement regarding a suitable augmentation.

Data generated by augmentation can be flagged in a representation of the embedding so as to enable an evaluation of an influence of the augmentation on the clusters. If the extension of the clusters becomes too great or diffuse as a result of the augmentation, then a strength of the augmentation used should be reduced.

### Contextual Information/Metainformation

The dataset can also comprise contextual information pertaining to the microscope data. The microscope data can in particular be microscope images, wherein at least one piece of contextual information is provided for a plurality or each of the microscope images. The contextual information can relate to or indicate, for example, one more of the following:
a (calendar) date of capture of the microscope data; a microscopy system and microscope settings used for capturing the microscope data; a sample carrier used; a type of sample under analysis; a sample preparation of a sample depicted in the microscope data; information regarding a patient to whom microscope data pertain;
a predefined division of the dataset into training and validation data;
a class membership; a segmentation mask or an image that is registered in relation to microscope data representing a microscope image and that differs from the microscope image in a capture or display characteristic.

The contextual information can be taken into account in the aforementioned analysis steps. For example, a division of the data points of homogeneous clusters into training and validation data can be carried out so that the training and validation data respectively contain data points of the same homogeneous cluster with different values of contextual information, wherein the value of the contextual information can designate, e.g., different patients for whom microscope images were captured. This ensures a greater diversity in the data used.

If both annotations and contextual information are provided for the microscope data of the dataset, then an embedding of the dataset can be analyzed to ascertain whether embedded data points with corresponding annotations form different clusters as a function of a value of a given piece of contextual information. If this is the case, an instruction can be output that the given contextual information should be input into the model together with microscope data (in the training and in the inference phase). For example, the contextual information can indicate a type or a specific model of a microscope component used, e.g. a type of a DIC slider used (DIC: differential interference contrast) or an illumination unit used. If, on the other hand, the embedding does not exhibit any clustering as a function of the piece of contextual information, then this contextual information seems to be less relevant and does not necessarily have to be taken into account in the training of the model.

### Machine-Learned Analysis Model for Analyzing the Embedding

Optionally, an embedding can be input into a machine-learned analysis model, which calculates a training design specification from the entered embedding. The training design specifications in question can take the form of the examples discussed in the foregoing.

The analysis model can be learned using training data (analysis model training data) which contains embeddings as input data and predefined training design specifications as associated target data. For example, outliers can be flagged in the training data of the analysis model so that the analysis model learns to identify certain data points as outliers in an entered embedding. The training data of the analysis model can also contain contextual information/metainformation so that the analysis model learns to take such information into account.

Different representations of an embedding can serve as input data for the machine-learned analysis model. The embedding can take the form of a data point cloud of embedded data points depicted by one or more images. A 2D embedding can in particular be represented as an image, wherein annotations are represented as additional values, e.g. as colors or greyscale. Contextual information can also be provided as an additional value for each point of a (2D) embedding. There is also no restriction here to, e.g., three color channels; rather, any number of channels can be provided for each embedded data point. Besides a 2D embedding, it is also possible to use an embedding space with any number of dimensions.

Annotations for the training data of the analysis model do not have to be determined manually or from an embedding. Instead, it is also possible to respectively determine hyperparameters for a plurality of datasets by AutoML methods and to use the determined parameters as annotations/target data in the training of the analysis model. Advantageously, this allows the analysis model to calculate hyperparameters from an embedding with relatively little computational effort upon completion of the training, which would only be possible with considerably more effort if AutoML were used for the same dataset.

### Implementation of Training and Inference Phase

Defining the training as a function of the training design specifications can be understood in the sense that the training design specifications are adopted automatically, recommended to a user or first tested by another program prior to an automatic adoption. For example, a number of training steps can be recommended, wherein another program checks that this number lies within acceptable limits.

The training is then carried out, if appropriate, with the adopted training design specifications. The model is thereby configured to calculate a processing result from microscope data.

Upon completion of the training, in the inference phase, microscope data to be processed that did not form part of the dataset can be input into the model. Different designs of the model are described in greater detail in the following.

### Model/Image Processing Model

The machine-learned model can be an image processing model and the microscope data input into the model can be or comprise microscope images. In general, the model can be designed for, inter alia, regression, classification, segmentation, detection and/or image-to-image transformation. The image processing model can in particular be configured to calculate at least one of the following as a processing result from at least one entered microscope image:
a statement regarding whether certain objects are present in the microscope image. This can include an object or instance re-identification by means of which it is in particular checked whether an object, an object type or an object instance identified in one microscope image is also depicted in other microscope images.
an inverse image transformation by means of which an inverse of a given image transformation is estimated.
geometric specifications relating to depicted objects, e.g. a position, size or orientation of an object; an identification, a number or characteristics of depicted objects. It is in particular also possible to determine a confluence, i.e. a proportion of the area of the microscope image that is covered by objects of a certain type.
a warning regarding analysis conditions, microscope settings, sample characteristics or image characteristics. Microscope settings can relate to, e.g., the illuminance or other illumination settings, detection settings or a focus.
an anomaly or novelty detection. If entered microscope data differ significantly from the microscope data of the training, an anomaly or a novelty vis-à-vis the training data is determined. The image processing model can also function as a watchdog and issue a warning in the event of discrepancies that are not predefined.
a control command, a recommendation of a control command for controlling the microscope or a microscope component, or a command/recommendation to carry out a subsequent image evaluation. The control command can relate to, e.g., a change in illumination, detection, image capture, focus, sample stage position, filters in use or the objective in use. The control command can also relate to auxiliary components in use, such as an immersion device or an adaptive optic, in particular a spatial light modulator (SLM) by means of which a wavefront is modified. A certain image evaluation can be recommended or commanded, e.g., as a function of which objects were ascertained in the microscope image. The control command can also relate to an AutoCorr setting, so that a correction ring of the objective is adjusted in order to compensate in particular aberrations.
a determination of capture parameters with which a subsequent microscope image is to be captured.
a parameter determination for a calibration, e.g. determining a position of and/or orienting at least one camera.
a specification regarding future maintenance (predictive maintenance). This can in particular be a specification of whether a particular microscope component has been subjected to wear and/or a recalibration will be necessary.
a model test result by means of which another image processing model or its output is tested, for example a model designed by AutoML. This model can correspond to one of the image processing models described in the present disclosure. In cases of a testing of a model output, a correction of the model output can also be recommended.
an output image in which, e.g., depicted objects are more clearly visible or are depicted in a higher image quality, or an output image in which a depiction of certain structures is suppressed. The improved visibility or higher image quality can relate to depicted objects in general, as in the case of, e.g., a noise reduction (denoising), resolution enhancement (super-resolution), contrast enhancement (e.g. an adjustment of the gamma value or a contrast spread) or deconvolution. The improved visibility can, however, also relate alone to specific objects, as in the case of a transformation between different contrast types, whereby a virtual staining of specific structures is achieved. For example, the transformation can occur between the contrast types bright field and DIC (differential interference contrast). A suppression of structures can occur, e.g., through an artefact removal or through a detail reduction of a background. The artefact reduction does not necessarily have to relate to artefacts already present in captured raw data, but can also relate to artefacts that are created through image processing, in particular in cases of a model compression. A model compression simplifies a machine-learned model in order to reduce the memory or computational requirements of the model, wherein the model accuracy can be slightly reduced and artefacts can occur as a result of the model compression. An image-to-image transformation for calculating the output image can also relate to a filling-in of image regions (inpainting), e.g. a filling-in of flaws or gaps as a function of surrounding image content. The output image can also be a density map of depicted objects, e.g. by marking cell or object centers. A white balance, an HDR image or a de-vignetting can also be calculated. A white balance removes a distorting color or hue from the input microscope image so that objects that are actually colorless are depicted as colorless in the output image. In an HDR image, a scale of possible brightness differences per color channel is increased compared to the input microscope image. De-vignetting removes an edge shading of the input microscope image or in general other effects that increase towards the edge of the image, such as a change in color, imaging errors or a loss in image sharpness. A signal separation (“unmixing”) is also possible in which one or more signal components are extracted, e.g. in order to estimate an extraction of a spectral range from a captured image. The image processing model can also comprise a generator of a GAN, e.g. of a StyleGAN.
a classification result that specifies a categorization into at least one of a plurality of possible classes as a function of a depicted image content of the microscope image. Different classes can relate to, e.g., the sample type, the sample carrier type or characteristics of the same, e.g. a size or number of certain objects or sample components. The presence of objects in the microscope image or in certain image regions can also be checked. Objects can comprise, e.g., cells, viruses, bacteria, parts of the same or particles. It is also possible to classify an object status, e.g. a cell stage, wherein it is in particular possible to discriminate between living and dead cells. The classes can also relate to microscope characteristics, microscope components or a capture type or an aptness for subsequent measuring and/or processing steps. The classification result can also relate to an input into the model in the form of a point cloud. The point cloud represents measurement results or feature vectors of microscope images in a dimensionally reduced feature space. The classification can also be a quality assessment, e.g. regarding the image capture or an image processing step carried out beforehand. A classification can optionally take the form of an ordinal classification in which a plurality of possible classes form an order, e.g. in the case of a quality assessment of sample carriers or a size estimation of depicted objects. A one-class classification is also possible in which it is estimated whether a certain class is present without defining another class in more detail. In all examples, a probability of class membership is specified. In particular in the case of an ordinal classification, it is also possible to estimate an intermediate result between predefined classes. The classifications mentioned in the foregoing can optionally be implemented via an “open set classification” in which it is detected whether input data stems from a distribution of the training data and can thus be assigned to one of the known classes, or whether it pertains to a new class that was not taken into account in the training of the model.
a regression result, which in principle can relate to the examples mentioned with respect to a classification or to, e.g., a determination of a fill level for sample vessels, a focus determination, an image quality determination or a height determination for multi-well plates, other sample carriers or other objects.
a light field calculation by means of which a 3D image of the sample is estimated from at least one input microscope image or input image data.
a segmentation, in particular a semantic segmentation or instance segmentation, or a detection of certain structures, e.g. of: a sample area, different sample types or sample parts, one or more different sample carrier areas, a background, a microscope component (e.g. holding clips or other parts for holding a sample carrier) and/or artefacts. A segmentation can occur by means of an interactive segmentation in which a user selects, in a one-off selection or in a number of iterations, image regions in the microscope image which should or should not belong to an object to be segmented. The segmentation can also be a panoptic segmentation in which a semantics and an instance of segmented objects is indicated. A detection can be understood as a specification of whether one or more of the aforementioned structures are present in the image, or as a specification of a location of one or more of said structures, wherein a specification of location can occur by means of image coordinates or, e.g., by means of a frame around the corresponding structure, which is generally called a bounding box. Specifications of size or other geometric object characteristics can also be output by the detection in a list.
a data reduction, by means of which a compressed representation of the entered at least one microscope image is produced. The data reduction can in particular take the form of a sparse or compressed representation (compressed sensing).
a model compression of a machine-learned model by means of which the model is simplified. It is possible to attain, for example, a runtime improvement by means of a parameter reduction. The model to be compressed can in particular correspond to one of the image processing models described in the present disclosure.
a model selection: It is ascertained which of a plurality of machine-learned models is to be used for a subsequent analysis or image processing.
an evaluation of a machine-learned model or of a model architecture of a machine-learned model, after completion of a model training or during a still ongoing model training (training observer).
an evaluation of a model output of an image processing model in order to calculate a refinement of model parameters of the image processing model by means of continuous active learning.
training data for a further machine-learned model. The training data in question can be constituted by any of the outputs mentioned here.
a supervision result of a workflow of a microscope. Image data can be assessed to check whether certain events have occurred, e.g. whether a general or specific sample carrier or a calibration object has been placed on a microscope stage. Spectrogram data of captured audio data or other representations of audio data can also be evaluated for the supervision of a workflow.
a confidence estimate of an image processing result of another image processing model, which can correspond, e.g., to one of the image processing models described in the present disclosure.
a selection of images from an image dataset, wherein selected images resemble the entered microscope image (image retrieval).

A type of training data can be chosen according to the aforementioned functions. In a supervised learning process, the training data also comprises, besides microscope data, predefined target data (ground truth data) to which the calculated processing result should ideally be identical. For a segmentation, the target data takes the form of, for example, segmentation masks. In the case of a virtual staining, the target data takes the form of, e.g., microscope images with chemical staining, fluorescence images or generally microscope images captured with a different contrast type than the microscope images to be entered.

### Architecture of the Model

In principle, an architecture of the model/image processing model can take any form. It can comprise a neural network, in particular a parameterized model or a deep neural network containing in particular convolutional layers. The model can include, e.g., one or more of the following: ⋅encoder networks for a classification or regression, e.g. ResNet or DenseNet; ⋅an autoencoder trained to generate an output that is ideally identical to the input; ⋅generative adversarial networks (GANs) ⋅encoder-decoder networks, e.g. U-Net; ⋅feature pyramid networks; ⋅fully convolutional networks (FCNs), e.g. DeepLab; ⋅sequential models, e.g. recurrent neural networks (RNNs), long short-term memory (LSTM) or transformers; ⋅fully-connected models, e.g. multi-layer perceptron networks (MLPs).

### General Features

The processes of methods described in the present disclosure can be carried out automatically or semi-automatically. For example, it can be provided that, after an automatic determination of the training design specifications, a user manually defines the training as a function of the training design specifications, e.g. adopts, modifies or discards recommended hyperparameters and a recommended division of the dataset. A determined recommendation can be implemented in an analogous manner either automatically or following manual approval or following approval by another automatically executed program.

Class labels: Different variant embodiments involve the use of microscope data or embedded data points which are respectively assigned a class label. More generally, these variants can also involve the use of microscope data or data points for which other annotations are provided. Corresponding class labels can be understood as corresponding annotations. For example, a confluence, i.e. an area covered by biological cells in a microscope image, can be specified as an annotation. A correspondence of the confluence or of some other annotation, which can be expressed in continuous values and is not restricted to discrete classes, can be assumed if a deviation is smaller than a predefined value. Alternatively, the confluence or other annotation can be divided into classes via predefined interval limits. These classes are taken into account in the analysis of the embedding and do not need to be applied in the training of the model.

Formulations such as “based on”, “using” or “as a function of” are intended to be understood as non-exhaustive, so that further dependencies can exist. For example, if an aptness of a dataset for a training is evaluated as a function of a determined characteristic, this does not exclude the possibility that further characteristics are also determined and taken into account for the evaluation of the aptness.

The expressions “weights” or “model weights” can be understood as synonymous with “model parameters” or “model parameter values” of a machine-learned model.

The term “validation data” as used herein can also comprise test data. Test data is not used to determine or select hyperparameters. Rather, test data is only used in a final quality evaluation of a ready-trained model.

Machine-learned models generally designate models that have been learned by a learning algorithm using training data. The models can comprise, for example, one or more convolutional neural networks (CNNs), wherein other deep neural network model architectures are also possible. By means of a learning algorithm, values of model parameters of the model are defined using the training data. A predetermined objective function can be optimized to this end, e.g. a loss function can be minimized. The model parameter values are modified to minimize the loss function, which can be calculated, e.g., by gradient descent and backpropagation.

The microscope can be a light microscope that includes a system camera and optionally an overview camera. Other types of microscopes are also possible, for example electron microscopes, X-ray microscopes or atomic force microscopes. A microscopy system denotes an apparatus that comprises at least one computing device and a microscope.

The computing device can be designed in a decentralized manner, be physically part of the microscope or be arranged separately in the vicinity of the microscope or at a location at any distance from the microscope. It can generally be formed by any combination of electronics and software and can comprise in particular a computer, a server, a cloud-based computing system or one or more microprocessors or graphics processors. The computing device can also be configured to control microscope components. A decentralized design of the computing device can be employed in particular when a model is learned by federated learning using a plurality of separate devices.

Descriptions in the singular are intended to cover the variants “exactly 1” as well as “at least one”. For example, the processing result calculated by the model is intended to be understood as at least one processing result. It is optionally possible for a plurality of the processing results described here to be calculated conjointly by the model from one input. The calculation of an embedding is also intended to be understood in the sense of at least one embedding. For example, embeddings can be calculated from the same dataset in different manners, which can yield complementary information. The same or different feature extractors can be used for different embeddings.

The characteristics of the invention that have been described as additional apparatus features also yield, when implemented as intended, variants of the method according to the invention. Conversely, a microscopy system or in particular the computing device can also be configured to carry out the described method variants.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 is a schematic illustration of an example embodiment of a microscopy system according to the invention.

FIG. 2 illustrates processes of an example embodiment of a method according to the invention;

FIGS. 3-7 respectively show an embedding of microscope data according to example embodiments of a method according to the invention;

FIG. 8 illustrates an embedding of microscope data according to example embodiments of a method according to the invention;

FIG. 9 illustrates processes of example embodiments of a method according to the invention;

FIG. 10 illustrates processes of example embodiments of a method according to the invention; and

FIG. 11 illustrates processes of example embodiments of a method according to the invention.

### DETAILED DESCRIPTION OF EMBODIMENTS

Different example embodiments are described in the following with reference to the figures.

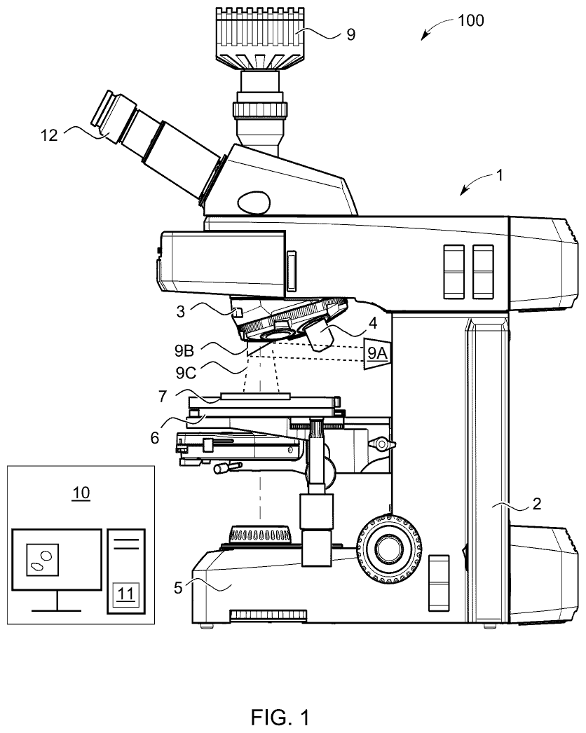

### FIG. 1

FIG. 1 shows an example embodiment of a microscopy system 100 according to the invention. The microscopy system 100 comprises a computing device 10 and a microscope 1, which is a light microscope in the illustrated example, but which in principle can be any type of microscope. The microscope 1 comprises a stand 2 via which further microscope components are supported. The latter can in particular include: an illumination device 5; an objective changer/revolver 3, on which an objective 4 is mounted in the illustrated example; a sample stage 6 with a holding frame for holding a sample carrier 7; and a microscope camera 9. When the objective 4 is pivoted into the light path of the microscope, the microscope camera 9 receives detection light from an area in which a sample can be located in order to capture a sample image. A sample can be to be any object, fluid or structure. In addition to or instead of the microscope camera 9, it is also possible to use an eyepiece 12. The microscope 1 optionally comprises an additional overview camera 9A for capturing an overview image of a sample carrier 7. A field of view 9C of the overview camera 9A is larger than a field of view of the microscope camera 9. In the illustrated example, the overview camera 9A views the sample carrier 7 via a mirror 9B. The mirror 9B is arranged on the objective revolver 3 and can be selected instead of the objective 4.

Microscope data is understood in the present disclosure as raw data captured by the microscope or data resulting from a subsequent processing of such raw data. Microscope data can in particular be a microscope image, i.e. an overview image of the overview camera 9A or a sample image of the sample camera/system camera 9. The microscope data is intended to be processed by a machine-learned model/image processing model. This model can be executed by a computer program 11 that forms part of a computing device 10. The design of the training of the model is essential for a highest possible quality of the machine-learned model. This is explained in the following with reference to the following figures.

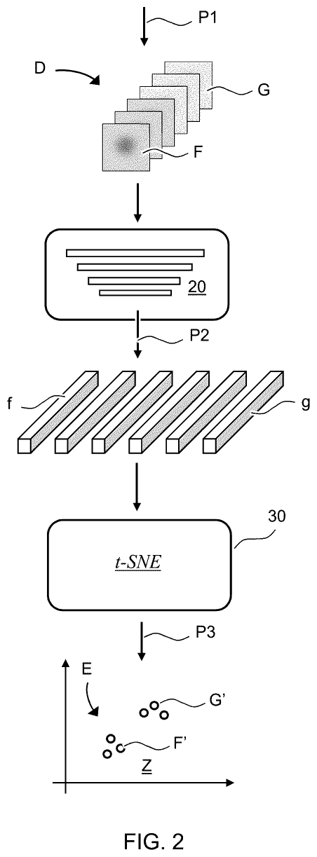

### FIG. 2

FIG. 2 schematically illustrates processes of an example embodiment of a method according to the invention. By means of the illustrated processes, microscope data F, G are embedded in a low-dimensional feature space Z. The computing device 10 or the computer program 11 mentioned with reference to FIG. 1 is designed to carry out this method.

In a process P1, a dataset D is obtained, e.g., captured with a microscope or loaded from a memory. The dataset D contains microscope data F, G, which in the illustrated example are captured microscope images, but which can also be formed by other image data or data derived from image data, e.g. by segmentation masks, time series or maps of identified cell centers. The microscope data F, G are intended to be used as training data for a machine-learned model, which will be discussed with reference to the later figures.

The microscope data F, G are first input into a feature extractor 20, which respectively calculates associated feature vectors f, g in a process P2. The information content of the feature vector f, g calculated for each microscope image F, G should essentially correspond to that of the associated microscope image. In the illustrated example, the feature extractor is a pre-trained machine-learned model. A feature vector f, g can be formed, e.g., by a tensor whose dimensionality is smaller than that of the microscope data F, G. With microscope images, dimensionality can be understood as a number of pixels.

The feature vectors f, g are then input into a unit 30 or function to calculate an embedding E. In the illustrated example, the unit 30 calculates a t-distributed stochastic neighbor embedding (t-SNE) from input feature vectors f, g, which was explained in greater detail in the foregoing general description. Whereas the feature extractor 20 converts each microscope image separately into a feature vector f, g, the t-SNE is calculated by taking all feature vectors f, g into account together.

The embedding E comprises an associated embedded data point F′, G′ for each feature vector f, g. In the illustrated example, the data points F′, G′ are mapped into a two-dimensional feature space Z, although higher-dimensional feature spaces are also possible. A distance between the data points F′, G′ is a measure of a similarity of the associated microscope data F, G. An analysis of the embedding E, in particular of a position of the embedded data points F′, G′ relative to one another, thus allows inferences to be drawn regarding characteristics of the microscope data F, G and regarding a composition of the dataset D.

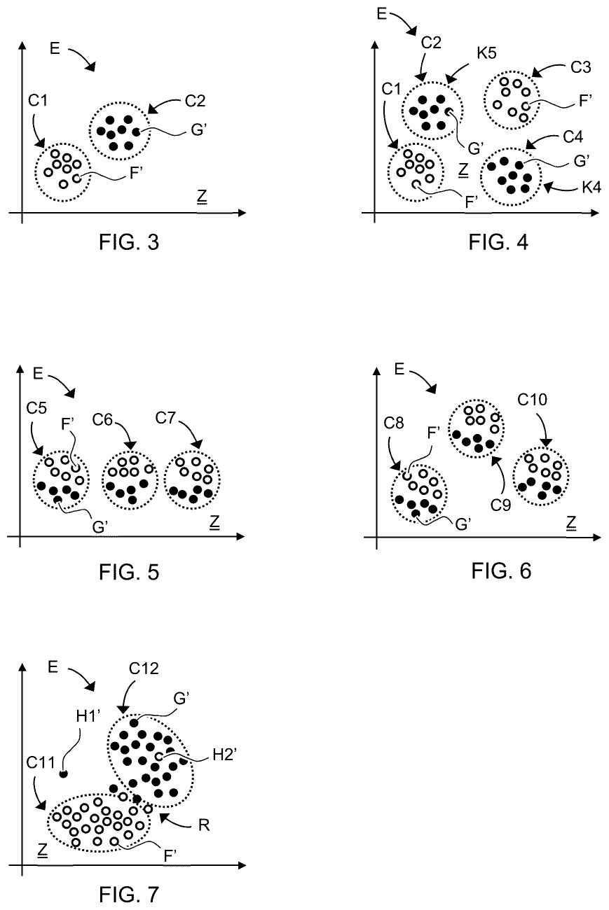

### FIGS. 3-7

Embeddings E for different datasets are shown schematically in FIGS. 3 to 7. In these examples, an annotation is respectively provided for the microscope data, e.g. a class label is respectively specified for each microscope image. The annotation for a microscope image applies accordingly to the associated embedded data point. In FIGS. 3 to 7, two different class labels are schematically discriminated by the depiction of the corresponding data points as a hollow circle or as a solid circle.

FIG. 3 shows an ideal case in which the data points F′ form a cluster C1 and the data points G′ form a cluster C2. A cluster is understood as an agglomeration of adjacent data points in the feature space Z. The clusters C1, C2 are separated according to the class label, i.e. the cluster C1 consists homogeneously exclusively of data points F′ with a given class label, while the cluster C2 consists homogeneously only of data points G′ with a given other class label. The clusters C1, C2 are clearly separated from each other. While FIG. 3 illustrates a simplified example, a corresponding example with real data is shown in FIG. 5 of Laurens van der Maaten, “Accelerating t-SNE using Tree-Based Algorithms” in Journal of Machine Learning Research 15 (2014) 1-21.

FIG. 4 shows a multimodal case in which the data points F′ with the same class label form multiple separate, compact clusters C1 and C3. The data points G′ which share a common class label likewise form multiple clusters C2 and C4. The clusters C1-C4 are homogeneous and are clearly separated from one another. While FIG. 4 illustrates a simplified example, a corresponding example with real data is illustrated in FIG. 6 of Laurens van der Maaten, “Accelerating t-SNE using Tree-Based Algorithms” in Journal of Machine Learning Research 15 (2014) 1-21.

FIG. 5 shows an embedding E in which an arrangement of the embedded data points F′, G′ forms a plurality of clusters C5-C7 that are not homogeneous. Rather, each of the clusters C5-C7 comprises data points F′ and G′ with different class labels. Such an embedding E can result from a bias, i.e. a systematic error or influence in the underlying microscope data. Due to the bias, the data points F′ of a class label do not form a single cluster but rather a plurality of clusters, in this example three clusters, that are shifted or separate relative to one another. The bias can be caused, for example, by different measurement devices which, although of the same type, can differ from one another or be operated, e.g., under different ambient conditions. Despite the multiple clusters C5-C7, the data points F′, G′ in this example can be separated into two groups as a function of their position in the feature space, which corresponds to the respective class label: the data points F′, G′ within one of the clusters C5-C7 can be separated according to their class label, here in a simplified manner by a class separation rule in the form of a horizontal separating line. In the illustrated example, this class separation rule can be generalized. That is to say that the class separation rule can be determined based on, e.g., the clusters C5 and C6 and it is subsequently verified whether the class separation rule also correctly separates the data points F′ and G′ according to their class labels for the cluster C7. This is the case here for a class separation rule in the form of a horizontal line. The negative effect of the bias is thus not so strong in this example so as to render the dataset unusable.

FIG. 6 shows a further embedding E in which the data points F′, G′ form multiple inhomogeneous clusters C8-C10. In contrast to FIG. 5, a location of a data point F′ and G′ in the feature space Z can no longer be reliably correlated with a given class label due to the effect of the bias. Rather, the bias overshadows the differences between the classes in a manner and to an extent that it is not possible to infer a class label of a single data point from its location in the feature space Z. It is not possible to establish a class separation rule based on some of the clusters (e.g. based on clusters C8 and C9) that would apply to all clusters C8-C10.

FIG. 7 schematically shows an embedding E in which the data points F′ and G′ for each class label respectively form a homogeneous cluster C11, C12. A cluster can be considered homogeneous when, e.g., at least 95% of its data points have the same class label. The cluster C12 has one data point H2′ whose class label diverges from those of the other data points G′ of this homogeneous cluster C12. This can occur, e.g., as the result of an incorrect annotation of the microscope data. The data point H2′ can be identified as an outlier based on its class label and its location in the embedding E. A further outlier is represented by the data point H1′, which is located at a significant distance from the nearest cluster. Such a case can result from an incorrect data capture, e.g. when a blank image is captured or an image is captured in a wrong position, or from an incorrect image processing, e.g. an incorrect cropping of a captured image. The data point H1′ can be identified as an outlier by its position in the embedding E while optionally taking into account its class label. Although the clusters C11 and C12 are separate in this example, they form a diffuse boundary region R. In the boundary region R, it is not possible to reliably predict a class label of a data point based solely on its location in the feature space Z.

The microscope data of the dataset is intended to be used for a training of a model. By analyzing the embedding of the dataset, it is possible to identify a suitable design for the implementation of the training or for the structure of the model. This is explained in the following using the division of the dataset into training and validation data and a potential expansion of the dataset as an example.

If an embedding according to FIG. 3 is established, then microscope data relating to a few data points is selected from each of the clusters C1 and C2 as validation data. The remaining microscope data can be used as training data.

In the case shown in FIG. 4, microscope data relating to a few data points is likewise selected, e.g. drawn randomly, from each of the clusters C1-C4 as validation data. Microscope data relating to a plurality of data points is also selected from each of the clusters C1-C4 as training data. The fact that the training data covers all clusters C1-C4 ensures that the model learns to process the corresponding structurally different data. The validation data in this case should cover all clusters so that a quality statement based on the validation data takes into account all groupings of different data. In cases of a high number of clusters of the same class, it can also be sufficient if the validation data is only drawn from a portion of the clusters. Moreover, the sizes of clusters of different magnitudes can be rendered approximate to one another. If the clusters C1 and C3 (of the same class) diverge significantly in the number of their data points, this ratio could lead to a model not learning a correct processing of data of a cluster or to an incorrect processing of data of a cluster going substantially undetected in the validation. For the training data and/or the validation data, a selection of measurement data relating to data points of different clusters of the same class can thus occur so that the respective numbers of data points per cluster of the same class approximate one another, in particular so that the same number of data points is selected per cluster. In contrast, in cases of a simple random selection of microscope data for the validation data, there is the risk that microscope data relating to a cluster is underrepresented or even not included in the validation data at all.

If clusters as depicted in the example of FIG. 5 are established in an analysis of the embedding, on the other hand, a different division into training and validation data is performed. In this example, it is important that a machine-learned model is not compromised by the bias present in the microscope data. The validation data is intended to enable a correct statement in this regard. To this end, it is important that the training and validation data do not contain microscope data relating to data points F′, G′ of all clusters C5-C7, as otherwise it would not be possible to detect an overfitting of the model based on the validation data. Advantageously, the microscope data relating to data points of one of the clusters, e.g. the microscope data relating to data points F′, G′ of the cluster C7, should instead be utilized exclusively as validation data and not as training data. The validation data thereby allows a statement regarding the generalizability of the model and the applicability of the model to microscope data having a different or an unknown bias, for example microscope data captured with a different microscope or under different ambient characteristics. Instead of a specific division into training and validation data, it is possible in cases like the one shown in FIG. 5 to specify which groups of microscope data should not be distributed between training and validation data but rather should only be utilized as either training or validation data. The specification can stipulate, e.g., that microscope data from the same day of capture should only be used as either training or validation data.

If an embedding like the one shown in the example of FIG. 6 is detected, a division of the dataset into training and validation data could occur as described for FIG. 5. It is likely, however, that a generalization of the model is not possible because of the bias. This could be established using the validation data with the aforementioned division. It is also possible in cases like the one shown in FIG. 6, alternatively or in addition to the aforementioned division of the dataset, for a warning to be output that it is unlikely that a qualitatively adequate model can be learned with the provided dataset.

In the example shown in FIG. 7, a division into training and validation data can be chosen as described in relation to FIG. 3. A cleaning of the dataset can, however, be carried out first via a removal of the outliers (the microscope data relating to the data points H1′ and H2′) or a display of the outliers to a user for checking or annotation correction. For microscope data whose embedding lies in the diffuse boundary region R, an increased susceptibility of a machine-learned model to error is likely. A suggestion can thus be output that further microscope data similar to the microscope data corresponding to the data points in the boundary region R should be added for a training. Further microscope data can also be generated automatically from the microscope data relating to data points of the border region R by augmentation. Microscope data whose embeddings lie in the boundary region R can be given more weight in the training, e.g. via a statistically more frequent use of this microscope data in the training or via a stronger weighting of this microscope data in the loss function.

Optional contextual information can also be taken into account. For example, it can be indicated as contextual information K4, K5 (see FIG. 4) which microscope was used to capture the microscope data. In this example, the different clusters C2, C4 relating to microscope data of the same class accordingly result from the use of different microscopes. However, different microscopes (with the same or similar setup) should not lead to significant structural differences in the microscope data, which can be estimated based on the distance between the clusters C2 and C4. Depending on a distance or a separation of the clusters C2 and C4, a suggestion can thus be output that further microscope data should be added with other values for the relevant piece of contextual information. In other examples, the contextual information can indicate different days of capture or ambient characteristics such as room lighting. More generally, a warning can be output when different clusters C2, C4 correlate with a piece of contextual information that indicates an external influence (e.g. a day of capture). No warning is output, on the other hand, if different clusters C2, C4 correlate with contextual information that relates to the nature of the data, e.g. if the contextual information indicates a fluorescence wavelength range used.

Further cases are also possible besides the illustrated examples, e.g. combinations of the examples shown or cases where data points of different classes are not separated in the feature space at all. In this case, it is unlikely that a correctly functioning classification model can be learned from the available microscope data, and a warning to this effect can be output.

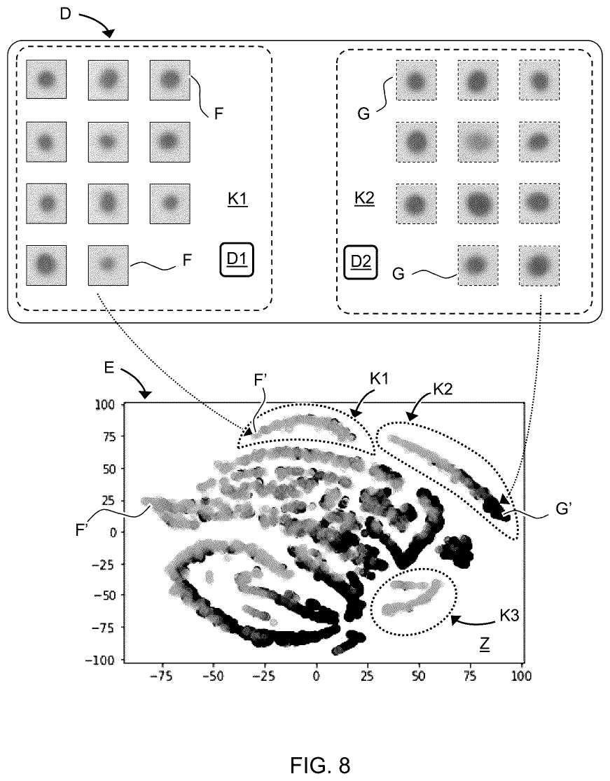

### FIG. 8

An example of an actual dataset D with an associated embedding E is shown in FIG. 8. A portion of the microscope data F and G of the dataset D is illustrated by way of example. The microscope data F shows a certain type of bacteria, which is indicated by a class label D1. The microscope data G, on the other hand, shows a different type of bacteria, which is designated accordingly by a class label D2. Contextual information K1, K2, . . . indicating, e.g., the day of capture of the respective microscope data F, G can also be provided.

The embedding E can be calculated via a t-SNE as described above. In the embedding, the data points F′ corresponding to the microscope data F and thus to a first type of bacteria are respectively represented by a grey point. The data points G′ corresponding to the microscope data G and thus to a second type of bacteria, on the other hand, are respectively represented by a black point. Dashed/dotted frames surround the data points captured on the same day of capture, which is indicated in the data by corresponding contextual information K1-K3. It is evident from the embedding E that there is a dominant bias associated with the day of capture as the result of which the data points are not separable according to the depicted type of bacteria. Clusters of data points are formed according to the days of capture, while the different types of bacteria are not reflected by separated clusters. The dataset is thus categorized as not apt for learning a model for the classification of depicted types of bacteria. A corresponding warning is output. Optionally, it is also possible for a division into training and validation data to be recommended: the microscope data of one or more given days of capture, e.g. the microscope data with the contextual information K1 and K2, are used exclusively as validation data and not as training data. This way the model cannot memorize the existing bias associated with the days of capture for K1 and K2. The validation data is thus informative regarding the question of how well the model can process microscope data of another (future) day of capture.

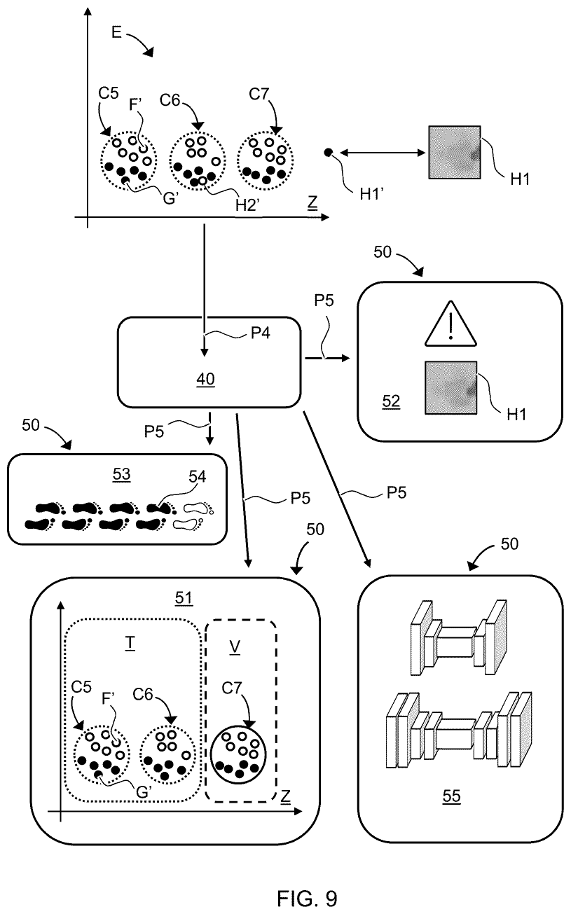

### FIG. 9

FIG. 9 illustrates processes of methods according to the invention in which different training design specifications 50 are calculated from an embedding E. The training design specifications 50 are taken into account in the definition of a training of the model.

An embedding E is input into a machine-learned analysis model 40, which analyzes the embedding in a process P4 in order to output one or more training design specifications 50 as a process P5.

For example, a division 51 into training data T and validation data V can be calculated as a training design specification 50. To this end, it is analyzed, e.g., to which of the cases shown in FIGS. 3-8 an embedding corresponds. As a function of the results of this analysis, the division described for the corresponding figure is chosen. Contextual information can optionally also be taken into account here.

The analysis model 40 can be learned using analysis model training data that comprises different embeddings as input data for the analysis model 40 and associated annotations as target data for the training. The annotations correspond precisely to the training design specifications 50, i.e., for instance, to a division into training and validation data. Instead of a machine-learned analysis model 40, it is also possible for an analysis algorithm that does not involve machine learning to calculate the training design specifications 50.

The training design specifications 50 can also comprise a specification of outliers 52. In the example shown, the data points H1′ and H2′, and thus the associated microscope data, are identified as outliers. The microscope data H1 corresponds to an incorrect case in which the image data does not show a bacterium, while the data point H2′ corresponds to an incorrect annotation.

The training design specifications 50 can also specify hyperparameters 53, in particular a number of training steps 54 up until the termination of a training. The number of training steps 54 is chosen to be higher, the higher a complexity of the arrangement of the embedded data points is, for example the higher a number of clusters (in particular per class).

The training design specifications 50 can further specify an appropriate model architecture or model complexity 55. This can be determined, e.g., based on a separation of classes or clusters in the embedding E, in particular when the embedding is based on feature vectors calculated by a feature extractor, as described with reference to FIG. 2. If data points are not correctly separated according to their class label, the feature extraction was presumably lacking in terms of complexity. Consequently, a more complex feature extractor can be used that comprises, e.g., more convolutional layers. A new embedding E can be calculated with this feature extractor and evaluated with respect to class separability. It is thereby possible to determine a feature extractor suitable for the dataset. The determined feature extractor is then used as part of the model. A corresponding training of the model is described with reference to the next figure.

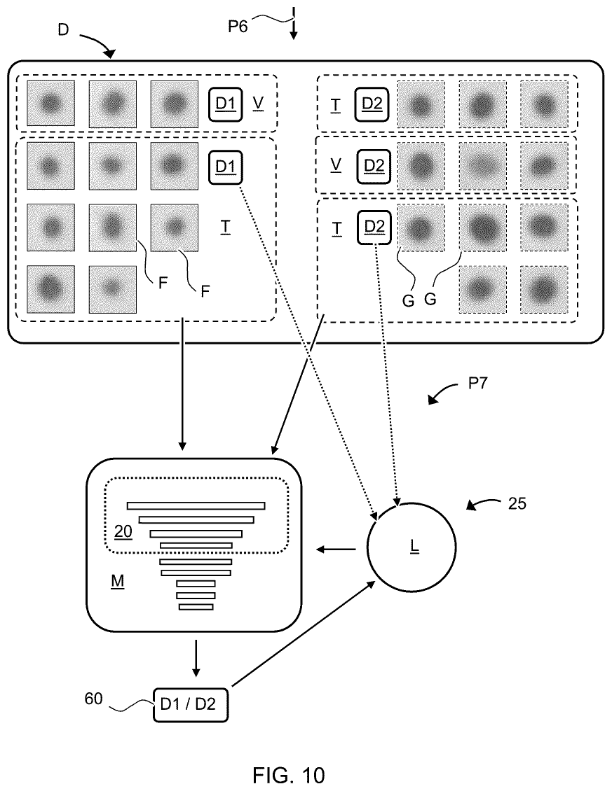

### FIG. 10

FIG. 10 illustrates a sequence of processes for a training 25 of a model M.

First, in a process P6, the training 25 is defined as a function of the training design specifications. For example, microscope data F, G of the dataset D are divided into training data T and validation data V according to a division determined based on an embedding of the dataset.

The training 25 is then carried out in a process P7. Microscope data F, G of the training data T are input into the model M, which calculates a processing result 60 therefrom. The processing result 60 should ideally correspond to annotations specified for the input microscope data F, G. The annotations here are class labels D1, D2. A loss function L captures differences between the processing results 60 and the specified class labels D1, D2. Depending on a result of the loss function L, model parameter values of the model M are iteratively adjusted via a gradient descent method and backpropagation. Upon completion of the training, the model M is trained for classification, i.e. a processing result 60 takes the form of a class designation.

The validation data V is used during and/or after the training 25 in order to evaluate a training progress during the training 25 or a model quality after completion of the training 25.

The model M comprises the feature extractor 20. The complexity and/or architecture of the feature extractor 20 determined based on the embedding is implemented here. Model parameter values of the feature extractor 20 are adjusted in the training 25 using the training data T (new). It is, however, in principle also possible to use a pre-trained feature extractor 20 in an invariable manner and to adjust solely the remaining model parameter values of the model M in the training 25.

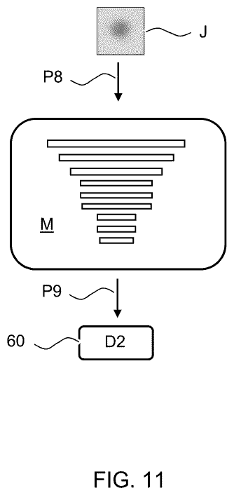

### FIG. 11

FIG. 11 shows the use of the model M in the inference phase, after completion of the training. In a process P8, microscope data J to be processed is input into the model M, which calculates a processing result 60 therefrom in a process P9. In the illustrated example, the microscope data J is a microscope image and the model M is an image processing model that calculates a classification result indicating whether (or which) given objects are contained in the microscope image.

Depending on the annotations used in the training of the model M, other processing results are possible, as explained in greater detail in the foregoing general description.

The variants described with reference to the different figures can be combined with one another. The described example embodiments are purely illustrative and variants are possible within the scope of the attached claims.

### LIST OF REFERENCE SIGNS

1 Microscope
2 Stand
3 Objective revolver
4 (Microscope) objective
5 Illumination device
6 Sample stage/microscope stage
7 Sample carrier
9 Microscope camera
9A Overview camera
9B Mirror
9C Field of view of the overview camera
10 Computing device
11 Computer program
12 Eyepiece
20 Feature extractor
25 Training of the model M
30 Unit/function for calculating the embedding
40 Analysis model
50 Training design specifications
51 Division of the dataset into training and validation data
52 Specification of outliers in the dataset, identified through analysis of the embedding
53 (Training) hyperparameters, recommended through analysis of the embedding
54 Number of training steps, recommended through analysis of the embedding
55 Model architecture or model complexity, recommended through analysis of the embedding
60 Processing result calculated by the model
100 Microscopy system
C1-C12 Cluster of embedded data points
D Dataset with microscope data for training the model
D1, D2 Annotation, in particular class/class label
E Embedding of the dataset in a low-dimensional feature space
F, G Microscope data/microscope images
f, g Feature vectors for the microscope data/microscope images F, G
F′, G′ Embedded data points
H1 Microscope data/microscope image representing an outlier
H1′ Embedded data point/outlier
H2′ Embedded data point/outlier
J Microscope data to be processed/microscope image
K1-K5 Contextual information: e.g. different days of capture
L Loss function in the training of the model M
M Machine-learned model/image processing model
P1-P9 Processes of methods according to the invention
R Border region between clusters
T Training data for a training of the model M
V Validation data for a training of the model M
Z Feature space

What is claimed is:

1. A computer-implemented method for generating a machine-learned model for processing microscope data, comprising:
receiving a dataset with microscope data for training the model;
calculating an embedding of the dataset in a feature space;
analyzing the embedding to determine training design specifications for a training of the model;
defining the training as a function of the training design specifications; and
carrying out the training, whereby the model is configured to calculate a processing result from microscope data to be processed.

2. The method according to claim 1,
wherein the calculating of the embedding comprises first inputting microscope data of the dataset into a machine-learned feature extractor, which calculates associated feature vectors from the microscope data, and representing or embedding the feature vectors in the feature space.

3. The method according to claim 1,
wherein the calculating of the embedding is carried out by means of a t-distributed stochastic neighbor embedding.

4. The method according to claim 1,
wherein the analyzing of the embedding comprises identifying clusters of embedded data points;
evaluating whether the clusters are homogeneous clusters of data points with a common class label;
wherein, in the case of homogeneous clusters, an aptness of the dataset for the training of the model is affirmed;
wherein, for inhomogeneous clusters, an aptness of the dataset for the training of the model is negated if data points within an inhomogeneous cluster are not separable according to their class labels.

5. The method according to claim 4,
wherein, in cases where data points within clusters are separable according to their class labels, an aptness is affirmed as a function of a generalizability of a class separation rule;
wherein a class separation rule for separating data points according to their class labels is derived from the data points of a plurality of the clusters; and
wherein the generalizability is affirmed if the class separation rule also holds true for data points of another of the clusters.

6. The method according to claim 1,
wherein a division of the dataset into training and validation data is recommended as a training design specification, wherein the division is determined based on an arrangement of embedded data points in the feature space.

7. The method according to claim 6,
wherein the analyzing of the embedding comprises identifying clusters of embedded data points;
wherein an evaluation is carried out to ascertain whether the clusters are formed homogeneously of data points with common class labels;
wherein, in the case of homogeneous clusters:
data points are selected from a plurality of clusters or from each cluster for the validation data and
data points are selected from each cluster for the training data;
wherein, for the division in the case of inhomogeneous clusters, data points of one of the clusters are selected for the validation data and no data points of this cluster are selected for the training data.

8. The method according to claim 1,
wherein an aptness of an already provided division of the dataset into training data and validation data is verified using the embedding,
wherein, in the case of homogeneous clusters of data points with common class labels, an aptness of the provided division is affirmed if the validation data includes data points from at least a plurality of the clusters and if the training data includes data points from all clusters;
wherein, in cases of inhomogeneous clusters, a provided division is categorized as suitable depending on whether an inhomogeneous cluster is present whose data points have been selected solely for validation data and not for training data.

9. The method according to claim 1,
wherein the training design specifications specify outliers of the dataset,
wherein the analyzing of the embedding comprises identifying a data point of the embedding as an outlier as a function of its position in the embedding,
wherein a data point is identified as an outlier if the data point is located further away from adjacent data points than a given threshold value, or if the data point is located in a cluster of data points with a different class label.

10. The method according to claim 1,
wherein the training design specifications specify training hyperparameters;
wherein a number of training steps up until a termination of the training is specified as one of the training hyperparameters,
wherein a complexity of the embedded data points in the feature space is ascertained, and
wherein the higher the complexity found, the higher the number of training steps is chosen.

11. The method according to claim 1,
wherein a model architecture or model complexity of the model to be trained is recommended as a training design specification by:
using different feature extractors to respectively calculate a set of feature vectors from the microscope data of the dataset, wherein the feature extractors differ in complexity or architecture;
respectively calculating an embedding from each set of feature vectors;
comparing the embeddings in order to select one of the feature extractors based on a separation of clusters of embedded data points; and
recommending the selected feature extractor for use as part of the model.

12. The method according to claim 1,
wherein, in the case of different numbers of data points per cluster, a selection of data points for the training data is made so that numbers of data points selected for different clusters approximate one another.

13. The method according to claim 1,
wherein, based on a distribution of data points in the embedding, it is recommended to add new microscope data to the dataset; wherein an addition of new data is recommended:
if a number of data points in a cluster is smaller than a given minimum number;
if it is ascertained that data points of a common class label form a plurality of clusters that are spaced apart from one another, wherein the clusters can be correlated with contextual information that is known not to cause a cluster separation; or
if a border region between clusters of different class labels is categorized as diffuse.

14. The method according to claim 1,
wherein a distribution of data points in the embedding is used to ascertain whether a cluster of data points of a class label overlaps with a cluster of data points of another class label, and
wherein a warning is output that an adequate separability is not satisfied in the event of an overlap;
wherein an augmentation by means of which new microscope data are generated from microscope data of the dataset is recommended or evaluated based on a distribution of data points in the embedding.

15. The method according to claim 1,
wherein the embedding is input into a machine-learned analysis model, which calculates the training design specifications from the embedding,
wherein the analysis model is learned using analysis model training data containing embeddings as inputs and predefined training design specifications as associated target data.

16. The method according to claim 1,
wherein the dataset comprises contextual information pertaining to the microscope data;
wherein the contextual information relates to one or more of the following:
a date of capture of the microscope data; a microscopy system and microscope settings used for capturing the microscope data; a sample carrier used; a type of sample under analysis; a sample preparation of a sample depicted in the microscope data; or information regarding a patient to whom microscope data pertain;
a predefined division of the dataset into training and validation data;
class labels; a segmentation mask; or an image that is registered in relation to microscope data representing a microscope image and that differs from the microscope image in a capture or display characteristic.

17. The method according to claim 1,
wherein the dataset comprises annotations and contextual information pertaining to the microscope data;
wherein the embedding of the dataset is analyzed to ascertain whether embedded data points with a common annotation form different clusters as a function of a value of a given piece of contextual information, and, if this is the case: outputting an instruction that the given piece of contextual information should be input into the model together with microscope data.

18. The method according to claim 1,
wherein the machine-learned model is an image processing model and the microscope data are microscope images,
wherein the image processing model is designed to calculate at least one of the following as a processing result from at least one microscope image:
a statement regarding whether certain objects are present in the microscope image;
geometric specifications relating to depicted objects; an identification, a number or characteristics of depicted objects;
a warning regarding analysis conditions, microscope settings, sample characteristics or image characteristics;
a control command or recommendation for controlling the microscope or for a subsequent image evaluation;
an output image in which depicted objects are more clearly visible or are depicted in a higher image quality, or a depiction of certain structures is suppressed;
a virtually stained output image corresponding to a transformation to a contrast type that differs from a contrast type of the microscope image;
a class label that specifies a categorization into at least one of a plurality of possible classes as a function of a depicted image content; and
a semantic segmentation, instance segmentation or detection of certain structures.

19. The method according to claim 1, further comprising:
inputting microscope data into the machine-learned model, which calculates a processing result from the input microscope data.

20. A microscopy system including:
a microscope for image capture; and
a computing device configured to execute a computer-implemented method for generating a machine-learned model for processing microscope data, the method comprising:
receiving a dataset with microscope data for training the model;
calculating an embedding of the dataset in a feature space;
analyzing the embedding to determine training design specifications for a training of the model;
defining the training as a function of the training design specifications; and
carrying out the training, whereby the model is configured to calculate a processing result from microscope data to be processed.

21. A computer program, comprising commands stored on a non-transitory computer-readable medium, which, when the program is executed by a computer, causes the execution of a method for generating a machine-learned model for processing microscope data, the method comprising:
receiving a dataset with microscope data for training the model;
calculating an embedding of the dataset in a feature space;
analyzing the embedding to determine training design specifications for a training of the model;
defining the training as a function of the training design specifications; and
carrying out the training, whereby the model is configured to calculate a processing result from microscope data to be processed.
